(19) United States
(12) Patent Application Publication
(10) Pub. No.: US 2005/0122034 A1
(43) Pub. Date: Jun. 9, 2005

(54) Electroluminescent device

(75) Inventor: Seiji Yamashita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/005,010

(22) Filed: Dec. 7, 2004

(30) Foreign Application Priority Data
Dec. 8, 2003 (JP) P.2003-408656

(51) Int. Cl. H05B 33/26; H05B 33/00

(52) U.S. Cl. 313/503; 313/506

(57) ABSTRACT

To provide an electroluminescent device capable of emitting light with high luminance in a large area of 0.25 m² or more and ensuring long emission life, the electroluminescent device a transparent conductive film has at least one of a transparent metal oxide and an organic material, and a striped or net-like structure containing a thin metal line; or the electroluminescent device has a fluorescent dye, an antioxidant and an ultraviolet absorbent.

### BACKGROUND OF THE INVENTION

1. Field of the Invention

The present invention relates to a large-sized, high-luminance and long-life electroluminescent device (hereinafter sometimes called an “EL device”) and a large-sized, high-luminance and long-life flat light source system using the device.

2. Background Art

Electroluminescent devices are roughly divided into an inorganic electroluminescent device such as particle dispersion-type device comprising a high dielectric material having dispersed therein phosphor particles and thin film-type device comprising a phosphor thin film interposed between dielectric materials, and an organic electroluminescent device. The present invention relates mainly to a particle dispersion-type inorganic electroluminescent device.

In the dispersion-type device, a light-emitting layer comprising a high dielectric polymer such as fluororubber or polymer having a cyano group, and containing a phosphor powder in the polymer is provided between a pair of electrically conducting electrode sheets with at least one electrode sheet being light-transmitting. Furthermore, in order to prevent the dielectric breakdown, a dielectric layer comprising a high dielectric polymer and containing a ferroelectric powder such as barium titanate in the polymer is usually provided. The phosphor powder used usually comprises ZnS as a matrix, where a proper amount of ion such as Mn, Cu, Cl, Ce, Au, Ag and Al is doped. The particle size is generally from 20 to 30 μm.

The dispersion-type device is being applied to backlight and display devices by virtue of its characteristic features that a flexible material constitution using a plastic substrate can be established because of no use of a high-temperature process at the fabrication of device, the device can be produced at a low cost through a relatively simple step without using a vacuum unit, and the emission color of the device can be easily controlled by mixing a plurality of phosphor particles differing in the emission color. However, this device disadvantageously has low emission luminance, insufficient white emission and short emission life. Even if pseudo-white color emission is formed by using a fluorescent dye in combination, the color balance is lost at the deterioration due to multiple causes such as deterioration rate of fluorescent dye and deterioration rate of phosphor particle. Because of this problem, its application range is limited in many cases. More improvements in emission luminance and emission efficiency are demanded.

In order to elevate the emission luminance of the dispersion-type device, various designs have been heretofore made primarily in the formation of phosphor particle. For example, JP-A-6-306355 discloses that two-stage baking and imposing an impact to the particle between bakings are useful for the elevation of luminance.

JP-A-3-86785 and JP-A-3-86786 describe a technique of performing the baking in an atmosphere of hydrochloric acid and hydrogen sulfide, thereby elevating the luminance.

Also, JP-A-2002-322469, JP-A-2002-322470 and JP-A-2002-322472 describe a technique of spraying a gaseous dissolved salt to cause thermal decomposition reaction and effect particle formation, thereby forming homogeneous phosphor particles.

However, by these methods only, a particle showing long-life electroluminescence with sufficiently high luminance cannot be obtained.

JP-B-7-58636 discloses that when the relationship between the size and distribution of phosphor particle and the thickness of light emitting layer is maintained at constant conditions, a high-luminance electroluminescent device can be provided. However, the high-luminance emission of the electroluminescent device by this method is still not satisfied. Furthermore, even if high-luminance emission is attained, the luminance half-life is extremely short or when the area is enlarged, high-luminance emission cannot be obtained.

JP-A-9-22781 describes a technique of using cerium oxide as an ultraviolet absorbing material, but the ultraviolet absorbing material used is a solid particle and therefore, when the ultraviolet absorbing material is dispersed in a film, this causes haze or the like to inhibit elevation of luminance or gives rise to deterioration of film and such adverse effects cannot be ignored.

JP-B-5-17676 and JP-B-5-32879 describe a technique of forming white color emission by using a fluorescent dye. This fluorescent dye is generally used by dissolving it in a resin or the like, grinding the resin, and dispersing the obtained micron-order particulate solid matter in the film together with a phosphor particle. However, this dye often decomposes due to ultraviolet ray, oxygen or heat generated upon emission of the electroluminescent device, as a result, reduction of luminance or loss of balanced white color emission disadvantageously occurs.

In recent years, display advertisement by a large-sized color photographic print or inkjet print or the like is increasing. The display method includes, for example, a method of allowing for enjoyment of an image formed on a support by irradiating light from the image side (reflection system) and a method of allowing for enjoyment by irradiating light from the back side of the image (transmission system). Under specific conditions such as indoor display or outdoor-night display, the latter transmission system is known to provide a clearer image.

Also, the display advertisement provides a greater advertisement effect as the size is larger and therefore, a large-size photosensitive material or print material for display advertisement is demanded. For the large-size display, a large-size flat light source using a fluorescent tube or a cold cathode tube is necessary, but such a light source is heavy and nonportable, greatly consumes the electric power and is largely restricted in the installation place or environment on use.

### SUMMARY OF THE INVENTION

The present invention has been made under these circumstances so as to solve the problems in conventional techniques and attain the following object.

That is, an object of the present invention is to provide an electroluminescent device having a large emission area of 0.25 m² or more and capable of giving high-luminance light emission and ensuring a long emission life.

As a result of intensive investigations, the present inventors have realized it important to, in addition to conventional techniques for elevating the efficiency of phosphor particle, improve the high-frequency driving characteristics of a large-area device, decrease the reduction of luminance due to ultraviolet ray, oxygen or heat generation and, and found a measure for realizing these. The object of the present invention can be attained by the following matters specifying the present invention and preferred embodiments thereof.
(1) An electroluminescent device comprising:
   a transparent conductive film comprising at least one of a transparent metal oxide and an organic material; and
   a net-like structure comprising a thin metal line.
(2) The electroluminescent device as described in (1), wherein the transparent conductive film has a surface resistivity of 0.01 to 100 Ω/□.
(3) The electroluminescent device as described in (1) or
(2), wherein the transparent metal oxide comprises an oxide of at least one of tin, zinc, antimony and indium.
(4) The electroluminescent device as described in any one of (1) to (3), wherein the organic material comprises a conjugated polymer.
(5) The electroluminescent device as described in any one of (1) to (4), wherein the thin metal line has a thickness of 0.5 to 20 μm.
(6) The electroluminescent device as described in any one of (1) to (5), wherein the net-like structure has a line pitch of 50 μm to 100 mm.
(7) The electroluminescent device as described in any one of (1) to (6), which comprises: a fluorescent dye; an antioxidant; and an ultraviolet absorbent.
(8) An electroluminescent device comprising:
   a transparent conductive film comprising at least one of a transparent metal oxide and an organic material; and
   a striped structure comprising a thin metal line.
(9) An electroluminescent device comprising: a fluorescent dye; an antioxidant; and an ultraviolet absorbent.
(10) The electroluminescent device as described in any one of (1) to (9), which comprises a phosphor particle having an average equivalent-sphere diameter of 0.1 to 15 μm.
(11) A flat light source system comprising an electroluminescent device as described in any one of (1) to (10), wherein the electroluminescent device is driven by an AC electric field of 500 Hz to 5 kHz.

According to the present invention, a high-luminance electroluminescent device having a long driving life can be provided.

### DETAILED DESCRIPTION OF THE INVENTION

The electroluminescent device of the present invention is characterized by satisfying the following requirement [1] or [2]:
[1] to have, as a transparent electrode, a transparent conductive film comprising at least one of a transparent metal oxide and an organic material, and a striped (parallel lines) or net-like structure comprising a thin metal line on the transparent conductive film, or
[2] to contain at least one fluorescent dye, at least one antioxidant and at least one ultraviolet absorbent.

An electroluminescent device satisfying both the requirements [1] and [2] is more preferred as a white-emitting electroluminescent device.

<Transparent Electrically Conducting Film>

The surface resistivity of the transparent conductive film for use in the present invention is preferably from 0.01 to 100 Ω/ε, more preferably from 0.1 to 30 Ω/□.

The transparent conductive film preferably comprises a transparent film such as polyethylene terephthalate and triacetyl cellulose, and a transparent conductive material on the transparent film. The transparent conductive film can be obtained by depositing and film-forming the transparent conductive material on the transparent film by vapor deposition, coating, printing or the like. The electroluminescent device of the present invention preferably has at least one of a transparent metal oxide such as indium-doped tin oxide (ITO), tin oxide and zinc oxide and an organic material as a conductive coat on the transparent film. In the EL device of the present invention, an arbitrary transparent electrode material generally employed is used for the conductive coat. Examples thereof include an oxide such as indium-doped tin oxide, antimony-doped tin oxide and zinc-doped tin oxide, a multilayer structure comprising high refractive index layers having interposed therebetween a silver thin film, and a conjugated polymer such as polyaniline and polypyrrole.

However, with such a transparent electrode material alone, a sufficiently low resistance may not be attained. In order to solve this problem, a striped or net like structure having a thin metal is disposed to improve the electrically conductive property. A net-like structure such as a comb, a grid or the like is preferred as an embodiment of the EL device of the present invention. The composition for the thin metal line is preferably copper, silver or aluminum. The thickness of the thin metal line can be arbitrarily selected but is preferably from about 0.5 to 20 ∞m. Thin metal lines in the net-like structure is preferably disposed at a pitch of 50 μm to 10 mm, more preferably from 100 μm to 1 mm.

The composition, thickness and pitch of the thin metal lines for the striped structure each is preferably the same embodiment as the net-like structure, as above described.

Although the light transmittance decreases when the striped or net-like structure is disposed, it is important to reduce this decrease as much as possible. A light transmittance of 90% to less than 100% is preferably ensured.

The thin metal line structure may be superposed on the transparent conductive film, or the transparent conductive material such as ITO may be coated or vapor-deposited on the thin metal line structure formed on a film.

<Back Electrode>

For another electrode (back electrode) paired with the transparent electrode, an arbitrary material having electric conductivity can be used. By taking account of, for example, the shape of the device produced and the temperature in the production process, an appropriate material is selected from metals such as gold, silver, platinum, copper, iron and aluminum, graphite and the like. Among these, since a high thermal conductivity is important, materials having a thermal conductivity of 2.0 W/cmdeg or more are preferred.

Also, in order to ensure high heat radiation and high electrically conducting property, a metal sheet or a metal mesh may be preferably used in the periphery of the EL device.

<Sealing-Water Absorption>

The EL device of the present invention is preferably processed at the end to eliminate the effect of moisture from the external environment by using an appropriate sealing material. In the case where the device substrate itself has a sufficiently high blocking property, the sealing is preferably performed by superposing a blocking sheet on the top of the device produced and sealing the circumference with a curable material such as epoxy. Also, in order to prevent curling of a plane-like device, the blocking sheet may be provided on both surfaces. In the case where the device substrate has permeability to moisture, the blocking sheet must be provided on both surfaces.

The blocking sheet is selected from glass, metal, plastic film and the like according to the purpose, but a moisture-proof film having a multilayer structure consisting of a layer formed of silicon oxide and an organic polymer compound described, for example, in JP-A-2003-249349 can be preferably used. An ethylene chloride trifluoride and the like can also be preferably used.

The sealing step is, as described in JP-B-63-27837, preferably performed in a vacuum or in an atmosphere purged with an inert gas and it is important, as described in JP-A-5-166582, to satisfactorily reduce the water content before the sealing step.

In producing such an EL device, a water-absorbing layer is preferably provided in the inside by using a blocking sheet. The water-absorbing layer preferably comprises a material having high water absorptivity and high water-holding ability, such as nylon and polyvinyl alcohol. It is also important to have high transparency. As long as the transparency is high, materials such as cellulose and paper can also be preferably used.

Also, a technique of coating the phosphor particle with a metal oxide or nitride to enhance the moisture-proofing property described in JP-A-4-230996 and U.S. Pat. No. 5,418,062 can be preferably used in combination with the moisture proofing of the film.

<White-Fluorescent Dye>

The end usage of the present invention is not particularly limited but in view of use as a light source, the emission color is preferably white.

The white color emission is preferably formed, for example, by a method of using a phosphor particle capable of emitting white light by itself, such as zinc sulfide phosphor activated with copper and manganese and gradually cooled after baking, or a method of mixing multiple phosphors capable of emitting light of three primary colors or complementary colors (for example, a combination of blue-green-red or bluish green-orange). In addition, the method described in JP-A-7-166161, JP-A-9-245511 and JP-A-2002-62530 is also preferred, where a part of the emission is caused to undergo wavelength conversion (emission) into green or red by using a phosphor of emitting blue or bluish green light and a fluorescent pigment or dye, thereby forming white emission. The fluorescent dye is preferably a rhodamine-based fluorescent dye. The color of the dye preferably has, on the CIE chromaticity coordinate (x, y), an x value of 0.30 to 0.4 and a y value of 0.30 to 0.40.

<Antioxidant>

In the present invention, a redox compound used in photosensitive materials can be preferably used as the antioxidant.

Preferred examples of the antioxidant for use in the present invention include hydroxamic acid derivatives (for example, the compounds described in JP-A-11-109576), cyclic ketones having, adjacently to the carbonyl group, a double bond substituted at both ends by an amino or hydroxyl group (for example, the compounds described in JP-A-11-327094, in particular, preferably the compounds represented by formula (Si) and described in paragraphs 0036 to 0071), sulfo-substituted catechols (for example, the compounds described in JP-A-11-143011), hydroquinones (for example, 4,5-dihydroxy-1,3-benzenedisulfonic acid, 2,5-dihydroxy-1,4-benzenedisulfonic acid, 3,4-dihydroxybenzenesulfonic acid, 2,3-dihydroxybenzenesulfonicacid, 2,5-dihydroxy-benzenesulfonic acid, 3,4,5-trihydroxybenzenesulfonic acid and salts thereof), and reducing agents represented by formulae (I) to (III) of JP-A-11-102045. Such a compound is preferably used by mixing it with the fluorescent dye or by adding and dispersing it in a binder where the fluorescent dye is dispersed.

In the EL device of the present invention, the antioxidant is preferably used in the range from 0.001 to 10 mol, more preferably from 0.01 to 10 mol, per mol of the fluorescent dye.

<Ultraviolet Absorbent>

In the present invention, an inorganic compound such as cerium oxide described in JP-A-9-22781 may be used, but an organic compound is preferably used.

In the present invention, a compound containing a triazine skeleton having a high molar extinction coefficient is preferably used as the ultraviolet absorbent. For example, the compounds described in the following publications and specifications can be used.

These compounds which are preferably added to photosensitive materials are also effective even when incorporated into the EL device of the present invention. Examples of the compound include those described in JP-A-46-3335, JP-A-55-152776, JP-A-5-197074, JP-A-5-232630, JP-A-5-307232, JP-A-6-211813, JP-A-8-53427, JP-A-8-234364, JP-A-8-239368, JP-A-9-31067, JP-A-10-115898, JP-A-10-147577, JP-A-10-182621, German Patent Publication No. 19739797A, EP711804A and JP-T-8-501291 (the term “JP-T” as used herein means a “published Japanese translation of a PCT patent application”).

It is important that the ultraviolet absorbent is disposed to prevent the phosphor particle and phosphor dye from being exposed to ultraviolet light. For this purpose, the ultraviolet absorbent is preferably used by adding and dispersing it in a binder where the phosphor particle and the phosphor dye are dispersed, or by adding it in the blocking sheet or water-absorbing film on the outer side than the transparent electrode. The ultraviolet absorbent is also preferably used by coating it on the surface of blocking sheet or water-absorbing film.

In the EL device of the present invention, the ultraviolet absorbent is preferably added in an amount of decreasing the light of 330 to 380 nm to at least ½ or less. The amount of the ultraviolet absorbent added is preferably 10 g or less per 1 m² of the emission plane of the EL device, otherwise the transparency of the electroluminescent device is impaired and the luminance decreases. The amount of the ultraviolet absorbent added is preferably 0.001 g or more, more preferably 0.001 g or more, per 1 m² of the emission plane of the EL device, though this may vary depending on the absorption coefficient of the ultraviolet absorbent.

<Phosphor Particle>

The electroluminescent phosphor particle for use in the present invention preferably has an average equivalent-sphere diameter of 0.1 to 15 μm, more preferably from 1 to 10 μm. The coefficient of variation in the equivalent-sphere diameter is preferably 30% or less, more preferably from 5 to 20%. As for the preparation method of the phosphor particle, a baking method, a urea fusion method, a spray-pyrolysis technique and a hydrothermal method can be preferably used.

The particle synthesized preferably has a multiple twin crystal structure. In the case of zinc sulfide, the distance between twin boundaries of the multiple twin crystal (stacking fault structure) is preferably from 1 to 10 nm, more preferably from 2 to 5 nm.

The fine phosphor particle which can be used in the present invention can be formed by a baking method (solid-phase process) widely used in this industry. For example, in the case of zinc sulfide, a fine particle powder (usually called raw powder) of 10 to 50 nm is prepared by a liquid phase process and this powder which is used as the primary particle is mixed with an impurity called an activator and subjected together with a fusing agent to a first baking in a mortar at a high temperature of 900 to 1,300° C. for 30 minutes to 10 hours to obtain particles.

The intermediate phosphor powder obtained by the first baking is repeatedly washed with ion exchanged water to remove alkali metal, alkaline earth metal and excess activator and co-activator.

Subsequently, the obtained intermediate phosphor powder is subjected to a second baking. The second baking is performed by heating (annealing) at a temperature lower than the first baking, that is, from 500 to 800° C., for a time period shorter than the first baking, that is, from 30 minutes to 3 hours.

By these bakings, many stacking faults are generated in the phosphor particle. Appropriate conditions are preferably selected for the first baking and second baking so that the phosphor particle can be formed as a fine particle and contain a larger number of stacking faults.

When an impact force in a certain strength range is applied to the first baked product, the density of stacking faults can be greatly increased without destroying the particle. Preferred examples of the method for applying an impact force include a method of contact-mixing intermediate phosphor particles with each other, a method of blending balls of alumina or the like in the intermediate phosphor powder and mixing the powder (ball mill method), a method of accelerating and colliding the particles, and a method of irradiating an ultrasonic wave.

By using such a method, a particle having stacking faults of 10 or more layers at intervals of 5 nm or less can be formed. The percentage thereof can be assessed by the percentage of cracked particles containing stacking faults of 10 or more layers at intervals of 5 nm or less when the particles are ground and cracked in a mortar into fragments having a thickness of almost 0.2 μm or less and observed through an electron microscope at an accelerating voltage of 200 kV. Particles having a thickness of less than 0.2 μm need not be ground and are as-is observed.

In the present invention, this percentage of particles preferably exceeds 50% pieces, more preferably 70% pieces. As this frequency is higher, more preferred. The distance between stacking faults is preferably narrower.

Thereafter, the intermediate phosphor is etched with an acid such as HCl to remove metal oxide adhering to the surface and further washed with KCN to remove copper sulfide adhering to the surface. This intermediate phosphor is then dried to obtain an EL phosphor.

In the case of zinc sulfide or the like, the phosphor particle is also preferably formed by a hydrothermal method so as to introduce a multiple twin crystal structure into the phosphor crystal. In the hydrothermal synthesis system, the particles are dispersed in a well-stirred water solvent and zinc ion and/or sulfur ion for bringing about the growth of particle are added in the form of an aqueous solution from the outside of the reaction vessel at a controlled flow rate for a predetermined time.

Accordingly, in this system, the particle can freely move in the water solvent and the ion added can diffuse in water to uniformly cause the growth of particle, so that the concentration distribution of activator or co-activator inside the particle can be varied and a particle unobtainable by a baking method can be obtained. As for the control of particle size distribution, the nucleation process and the growth process can be distinctly separated and at the same time, the supersaturation degree during the growth of particle can be freely controlled, so that the particle size distribution can be controlled and monodisperse zinc sulfide particles having a narrow size distribution can be obtained. For controlling the particle size and realizing a multiple twin crystal structure, an Ostwald ripening step is preferably provided between the nucleation process and the growth process.

For example, zinc sulfide crystal has very low solubility in water and this property is very disadvantageous for growing the particle by an ionic reaction in an aqueous solution. The solubility of zinc sulfide in water increases as the temperature is elevated, but water reaches the supercritical state at 375° C. or more and the solubility of ion sharply decreases. Accordingly, the temperature at the preparation of particle is preferably from 100 to 375° C., more preferably from 200 to 375° C. The time spent for the preparation of particle is preferably 100 hours or less, more preferably from 5 minutes to 12 hours.

As another method for increasing the solubility of zinc sulfide in water, a chelating agent is preferably used in the present invention. The chelating agent for Zn ion preferably has an amino group or a carboxyl group and specific examples thereof include ethylenediaminetetraacetic acid (hereinafter referred to as “EDTA”), N,2-hydroxyethyl ethylenediaminetriacetic acid (hereinafter referred to as “EDTA-OH”), diethylenetriaminepentaacetic acid, 2-aminoethylethylene glycol tetraacetic acid, 1,3-diamino-2-hydroxypropanetetraacetic acid, nitrilotriacetic acid, 2-hydroxyethyliminodiacetic acid, iminodiacetic acid, 2-hydroxyethyl glycine, ammonia, methylamine, ethylamine, propylamine, diethylamine, diethylenetriamine, triaminotriethylamine, allylamine and ethanolamine.

In the case of preparing the phosphor particle by a direct precipitation reaction between constituent metal ion and chalcogen anion without using a constituent element precursor, the solutions of both ions must be rapidly mixed and therefore, a double jet-type mixer is preferably used.

A urea fusion method is also preferred as the phosphor forming method usable in the present invention. The urea fusion method is a method of using fused urea as the medium for synthesizing a phosphor. In a solution where urea is fused by maintaining a temperature higher than the melting point, substances containing elements for constituting the phosphor matrix or activator are dissolved. If desired, a reactive agent is added. For example, in the case of synthesizing a sulfide phosphor, a sulfur source such as ammonium sulfate, thiourea or thioacetamide is added to cause a precipitation reaction. When the temperature of the resulting fused solution is gradually elevated to about 450° C., a solid where a phosphor particle and a phosphor intermediate are uniformly dispersed in a resin originated in the urea is obtained. This solid is finely ground and then baked in an electric furnace while thermally decomposing the resin. By selecting the baking atmosphere from inert atmosphere, oxidative atmosphere, reducing atmosphere, ammonia atmosphere and vacuum atmosphere, a phosphor particle comprising an oxide, sulfide or nitride matrix can be synthesized.

A spray-pyrolysis technique is also preferred as the phosphor forming method usable in the present invention. A phosphor precursor solution is formed into a fine liquid droplet by using an atomizer and through condensation or chemical reaction within the liquid droplet or chemical reaction with an atmosphere gas in the periphery of liquid droplet, a phosphor particle or a phosphor intermediate product can be synthesized. By optimizing the conditions for the formation of liquid droplet, fine spherical particles homogenized in trace impurities and narrowed in the particle size distribution can be obtained. As for the atomizer for producing a fine liquid droplet, a two-fluid nozzle, an ultrasonic atomizer or an electrostatic atomizer is preferably used. The fine liquid droplet produced by the atomizer is introduced with a carrier gas into an electric furnace or the like, dehydrated-condensed by heating, and further through a chemical reaction or sintering of the substances in the liquid droplet with each other or a chemical reaction with an atmosphere gas, a phosphor particle or a phosphor intermediate product is obtained. The obtained particle is, if desired, additionally baked.

For example, in the case of synthesizing a zinc sulfide phosphor, a mixed solution of zinc nitrate and thiourea is atomized and thermally decomposed at about 800° C. in an inert gas (for example, nitrogen), whereby a spherical zinc sulfide phosphor is obtained. When trace impurities such as Mn, Cu and rare earth are dissolved in the starting mixed solution, these impurities act as an emission center. Also, when a mixed solution of yttrium nitrate and europium nitrate is used as a starting solution and thermally decomposed at about 1,000° C. in an oxygen atmosphere, an europium-activated yttrium oxide phosphor is obtained.

In the liquid droplet, the components need not be all dissolved and ultrafine particulate silicon dioxide may also be contained. When a fine liquid droplet containing zinc solution and ultrafine particulate silicon dioxide is thermally decomposed, a zinc silicate phosphor particle is obtained.

Other examples of the phosphor forming method which can be in the present invention include a vapor phase method such as laser-ablation method, CVD method, plasma CVD method, sputtering and method combining resistance heating and electron beam process with fluidized oil surface deposition, and a liquid phase method such as double decomposition method, method utilizing a thermal decomposition reaction of precursor, reversed micelle method, method combining such a method with high-temperature baking, and freeze drying method.

In these methods, a fine particle having a size of 0.1 to 10 μm, which is preferred in the present invention, can be obtained by controlling the conditions at the preparation of particle.

The phosphor particle is preferably imparted with waterproofness and water resistance by covering it, as described in Japanese Patent No. 2,756,044 and U.S. Pat. No. 6,458,512, with a non-emitting shell layer comprising a metal oxide or a metal nitride and having a thickness of 0.01 μm or more.

Also, a technique of forming a double structure consisting of a core part containing an emission center and a non-emitting shell part, thereby enhancing the light penetration efficiency described in International Publication No. 02/080626, pamphlet, can be preferably used.

The phosphor particle more preferably has a non-emitting shell layer on the particle surface. This shell layer is preferably provided to a thickness of 0.01 μm or more, more preferably from 0.01 to 1.0 μm, by a chemical method subsequently to the preparation of a fine semiconductor particle which works out to the core of the phosphor particle.

The non-emitting shell layer can be formed from an oxide, a nitride, an oxynitride, a substance having the same composition as the matrix phosphor particle on which the substance is formed and not containing an emission center, or a substance epitaxially grown on the matrix phosphor particle and differing in the composition.

The non-emitting shell layer can be formed, for example, by a vapor phase method such as laser-ablation method, CVD method, plasma CVD method, sputtering and method combining resistance heating and electron beam process with fluidized oil surface deposition, a liquid phase method such as double decomposition method, sol-gel method, ultrasonic chemical method, method utilizing a thermal decomposition reaction of precursor, reversed micelle method, method combining such a method with high-temperature baking, hydrothermal method, urea fusion method and freeze drying method, or a spray-pyrolysis technique.

In particular, a hydrothermal method, a urea fusion method and a spray-pyrolysis technique which are suitably used for the formation of phosphor particle is also suited for the synthesis of the non-emitting shell layer.

For example, in the case of providing a non-emitting shell layer on the surface of a zinc sulfide phosphor particle by using a hydrothermal method, a zinc sulfide phosphor working out to a core particle is added to a solvent and suspended. Similarly to the particle formation, a metal ion working out to the non-emitting shell layer material and, if desired, a solution containing anion are added from the outside of the reaction vessel each at a controlled flow rate for a predetermined time. By thoroughly stirring the inside of the reaction vessel, the particle can be made to freely move in the solvent and at the same time, the ion added can diffuse in the solvent to uniformly cause the particle growth, so that a non-emitting shell layer can be uniformly formed on the core particle surface. The obtained particle is baked, if desired, whereby a zinc sulfide phosphor particle having on the surface thereof a non-emitting shell layer can be synthesized.

In the case of providing a non-emitting shell layer on the surface of a zinc sulfide phosphor particle by using a urea fusion method, a zinc sulfide phosphor is added in a urea solution having dissolved and fused therein a metal salt working out to the non-emitting shell layer material. The zinc sulfide does not dissolve in urea and therefore, the temperature of the solution is elevated similarly to the particle formation to obtain a solid where a zinc sulfide phosphor and a non-emitting shell layer material are uniformly dispersed in a resin originated in the urea.

This solid is finely ground and then baked in an electric furnace while thermally decomposing the resin. By selecting the baking atmosphere from inert atmosphere, oxidative atmosphere, reducing atmosphere, ammonia atmosphere and vacuum atmosphere, a zinc sulfide phosphor particle having on the surface thereof a non-emitting shell layer comprising an oxide, a sulfide or a nitride can be synthesized.

In the case of providing a non-emitting shell layer on the surface of a zinc sulfide phosphor particle by using a spray-pyrolysis technique, a zinc sulfide phosphor is added in a solution having dissolved therein a metal salt working out to the non-emitting shell layer material. This solution is atomized and thermally decomposed, whereby a non-emitting shell layer is produced on the surface of a zinc sulfide phosphor particle. By selecting the thermal decomposition atmosphere or additional baking atmosphere, a zinc sulfide phosphor particle having on the surface thereof a non-emitting shell layer comprising an oxide, a sulfide or a nitride can be synthesized.

The activator of the phosphor particle is preferably at least one ion selected from copper, manganese, silver, gold and rare earth elements.

The co-activator is preferably at least one ion selected from chlorine, bromine, iodine and aluminum.

The electroluminescent phosphor is described in more detail below.

The particle matrix material preferred in the present invention is specifically a fine semiconductor particle comprising one or multiple element(s) selected from the group consisting of Group II elements and Group VI elements and one or multiple element(s) selected from the group consisting of Group III elements and Group V elements. A semiconductor having a necessary emission wavelength region is arbitrarily selected. Examples thereof include CdS, CdSe, CdTe, ZnS, ZnSe, ZnTe, CaS, MgS, SrS, GaP, GaAs and a mixed crystal thereof. Among these, ZnS, CdS and CaS are preferred.

Other preferred examples of the particle matrix material include BaAl₂S₄, CaGa₂S₄, Ga₂O₃, Zn₂SiO₄, Zn₂GaO₄, ZnGa₂O₄, ZnGeO₃, ZnGeO₄, ZnAl₂O₄, CaGa₂O₄, CaGeO₃, Ca₂Ge₂O₇, CaO, Ga₂O₃, GeO₂, SrAl₂O₄, SrGa₂O₄, SrP₂O₇, MgGa₂O₄, Mg₂GeO₄, MgGeO₃, BaAl₂O₄, Ga₂Ge₂O₇, BeGa₂O₄, Y₂SiO₅, Y₂GeO₅, Y₂Ge₂O₇, Y₄GeO₈, Y₂O₃, Y₂O₂S, SnO₂ and a mixed crystal thereof.

The emission center is preferably a metal ion such as Mn and Cr, or a rare earth.

By selecting the matrix material and using several phosphors, white light emission in the range of 0.3<x<0.4 and 0.3<y<0.4 on the chromaticity can be obtained without using substantially no dye or no fluorescent dye.

<Binder>

The El device of the present invention basically has a constitution that a light emitting layer is interposed between a pair of opposing electrodes with at least one electrode being transparent. A dielectric layer is preferably provided adjacently between the light emitting layer and the electrode.

The light emitting layer is formed of a material obtained by dispersing phosphor particles in a binder. Examples of the binder which can be used include polymers having a relatively high dielectric constant, such as cyanoethyl cellulose-based resin, and resins such as polyethylene, polypropylene, polystyrene-based resin, silicone resin, epoxy resin and vinylidene fluoride. In this resin, a fine particle having a high dielectric constant, such as BaTiO₃ and SrTiO₃, can be appropriately mixed to adjust the dielectric constant. The particles can be dispersed by using a homogenizer, a planetary kneader, a roll kneader, an ultrasonic disperser or the like.

For the dielectric layer, an arbitrary material can be used as long as it has high dielectric constant, high insulating property and high dielectric breakdown voltage. This material is selected from metal oxides and nitrides and examples thereof include TiO₂, BaTiO₃, SrTiO₃, PbTiO₃, KNbO₃, PbNbO₃, Ta₂O₃, BaTa₂O₆, LiTaO₃, Y₂O₃, Al₂O₃, ZrO₂, AlON and ZnS. The dielectric layer may be provided as a uniform film or a film having a particle structure.

The light emitting layer and the dielectric layer each is preferably coated by using a spin coating method, a dip coating method, a bar coating method, a spray coating method or the like. In particular, a method applicable to any printing surface, such as screen printing method, or a method where continuous coating can be performed, such as slide coating method, is preferred. For example, in the screen printing method, a dispersion obtained by dispersing fine phosphor or dielectric particles in a polymer solution having a high dielectric constant is coated through a screen mesh. The layer thickness can be controlled by selecting the thickness of mesh, the opening ratio or the number of coatings. When the dispersion is changed, not only the phosphor or dielectric layer but also the back electrode layer can be formed. Furthermore, large-area formation can be easily obtained by changing the size of the screen.

<Light Emitting Layer>

In the electroluminescent device of the present invention, the thickness of the light emitting layer is preferably from 1 to 25 μm, more preferably from 3 to 20 μm.

The lower limit of the thickness of the light emitting layer is the phosphor particle size but for ensuring smoothness of the device, the thickness of the light emitting layer is preferably from 1 to 5 times the phosphor particle size.

The total thickness of the light emitting layer and the dielectric layer which is provided adjacently, if desired, is preferably from 2 to 10 times, more preferably from 3 to 5 times, the average phosphor particle size.

In the above-described device constitution, when the fluctuation of the distance between electrodes is viewed as the center line average roughness Ra, the device preferably has a smoothness of (d*⅛) or less based on the thickness d of the light emitting layer.

<Dielectric Layer>

The dielectric material for use in the EL device of the present invention may be a thin-film crystal layer or may have a particle shape. A combination thereof may also be used. The dielectric layer containing the dielectric material may be provided on one side of the phosphor particle layer but is preferably provided on both sides of the phosphor particle layer. In the case of a thin-film crystal layer, a thin film may be formed on the substrate by a vapor phase process such as sputtering. The film may also be a sol-gel film using an alkoxide of Ba, Si or the like. In the case of a particle-shaped dielectric material, the size is preferably sufficiently small for the size of the phosphor particle. More specifically, the size is preferably from ⅓ to 1/1,000 the phosphor particle size.

Other than these, in the device constitution of the present invention, a substrate, a transparent electrode, a back electrode, various protective layers, a filter, a light scattering/reflecting layer or the like can be provided, if desired. Particularly, as for the substrate, a flexible transparent resin sheet can be used, in addition to a glass substrate and a ceramic substrate.

In the present invention, the above-described materials for constituting the EL device are preferably combined appropriately, whereby a high-luminance and high-efficiency EL device can be provided.

According to the preferred embodiment described above, the electroluminescent device of the present invention can emit high-luminance light. Despite high-Luminance emission, driving with power consumption as small as 100 W/m² or less can be realized. In this way, the power consumption is decreased and the heat generation is thereby reduced, as a result, the device itself is enhanced in the durability and prolonged in the life. Furthermore, since sufficiently high luminance can be provided for a transmitted print image having a high image quality with a maximum density of 1.5 or more, a large-area advertisement or the like having a high image quality can be realized.

<Voltage and Frequency>

The dispersion-type electroluminescent device is usually driven by AC, typically by using an AC power source of 100 V at 50 to 400 Hz. When the area is small, the luminance increases almost in proportion to the applied voltage and frequency. However, in the case of a large-area device of 0.25 m² or more, the capacitance component of the device increases and the impedance matching between the device and the power source may be slipped or the time constant necessary for accumulating electric charge in the device increases, as a result, even when a high voltage particularly at a high frequency is applied, failure in sufficiently supplying electric power is liable to occur. In particular, when an device of 0.25 m² or more is driven by AC at 500 Hz or more, the applied voltage often decreases for the increase of the driving frequency, and low luminance frequently results.

On the other hand, the electroluminescent device of the present invention can be driven at a high frequency even when the size is as large as 0.25 m² or more, and can realize high luminance. The driving frequency is preferably from 500 Hz to 5 kHz, more preferably from 800 Hz to 3 kHz.

### EXAMPLES

### Example 1

<Phosphor Particle A>

In an alumina-made crucible, a dry powder containing 25 g of a zinc sulfide (ZnS) particle powder having an average particle size of 20 nm, in which copper sulfate was added in an amount of 0.07 mol % based on ZnS, was charged together with NaCl and MgCl as fusing agents as well as an appropriate amount of an ammonium chloride (NH₃Cl) powder and a magnesium oxide powder in an amount of 20 wt % based on the phosphor powder. These were baked at 1,200° C. for 3.5 hours and then the temperature was lowered. The resulting powder was taken out and dispersed by grinding in a ball mill. Thereto, 5 g of ZnCl₂ and copper sulfate in an amount of 0.10 mol % based on ZnS were added and 1 g of MgCl₂ was further added to prepare a dry powder. The powder obtained was again charged into the alumina crucible and baked at 700° C. for 6 hours. At this time, the baking was performed in an atmosphere under flow of a 10% hydrogen sulfide gas.

The baked particle was again ground, dispersed and precipitated in H₂O at 40° C. and after removing the supernatant, washed. Thereto, a 10% hydrochloric acid solution was added to disperse-precipitate the particle and the supernatant was removed. After removing unnecessary salts, the particle was dried, and Cu ion and the like on the surface was removed with a 10% KCN solution heated at 70° C.

Subsequently, the surface layer corresponding to 10 wt % of the entire particle was removed by etching with 6N hydrochloric acid.

The particles obtained were further sieved and small-size particles were taken out.

The thus-obtained phosphor particles had an average particle size of 10.3 μm and a coefficient of variation of 20%, and exhibited blue-green light emission having a luminescence peak of 500 nm. When the particles were cracked in a mortar and fragments having a thickness of 0.2 μm or less were taken out and observed through an electron microscope at an accelerating voltage of 200 KV, at least 80% or more of cracked particles were containing a portion having stacking faults-of 10 or more layers at intervals of 5 nm or less.

<Phosphor Particle B>

Baking was performed at 1,200° C. for 3.5 hours under the same conditions as in the preparation of Phosphor Particle A except for preparing a dry powder containing 25 g of a zinc sulfide (ZnS) particle powder having an average particle size of 20 nm, in which copper sulfate and manganese carbonate were added in an amount of 0.08 mol % and 0.2 mol %, respectively, based on ZnS. The subsequent steps were performed in the same manner as in the production process of Phosphor Particle A, whereby Phosphor Particle B was produced.

The thus-obtained Phosphor Particle B had an average particle size of 9.3 μm and exhibited orange light emission, and at least 85% or more of fragments of this particle had stacking faults of 10 or more layers at intervals of 5 nm or less.

By using Phosphor Particles A and B obtained above, a white EL device was produced by the following method.

Fine BaTiO₂ particles having an average particle size of 0.02 μm were dispersed in a 30 wt % cyanoresin solution and the obtained solution was coated on a 75 μm-thick aluminum sheet (back electrode) to form a dielectric layer having a thickness of 25 μm and then dried at 120° C. for 1 hour by using a hot air dryer.

Phosphor Particles A and B were mixed at a ratio of giving an emission color of x=3.3±0.2 and y=3.4±0.2 on the CIE chromaticity coordinate and dispersed in a cyanoresin solution having a concentration of 30 wt %. The obtained dispersion was coated on an ITO-coated transparent film (transparent electrode) of 0.5 m×0.7 m to form a light emitting layer having a thickness of 20 μm on the dielectric layer and then dried at 120° C. for 1 hour by using a hot air dryer.

A terminal for external connection was taken out from each of the transparent electrode and the back electrode of the device by using a copper aluminum sheet having a thickness of 80 μm and the device was interposed between two water-absorbing sheets comprising nylon 6 and between two moisture-proof sheets having an SiO₂ layer, and press-bonded under heat.

The thus-fabricated light emitting device of the present invention was designated as Sample 1. Based on Sample 1, devices were fabricated by changing the surface resistivity of the transparent conductive film and the thickness of the light emitting layer and evaluated on the luminance when driven at 100 V and 1 KHz.

A thin metal line structure on the ITO coated above was formed to have a net-like structure that has a square of a line pitch of 200 μm, a height of 3 μm and a line width of 5 μm.

The results are shown in Table 1.

TABLE 1

| | | Phosphor | | |
|---|---|---|---|---|
| | Transparent Conductive Film, | Particle Size | Relative | |
| Sample No. | and Resistance thereof (Ω/□) | (μm) | Luminance | Others |
| 1 | ITO alone | 10.0 | 100 | Large heat was |
| Comparison | 50 | | | generated. |
| 2 | ITO alone | 10.0 | 110 | Heat was |
| Comparison | 20 | | | generated. |
| 3 | ITO + thin Cu line | 10.0 | 140 | |
| The invention | 20 | | | |
| 4 | ITO + thin Cu line 5 | 10.0 | 180 | |
| The invention | | | | |
| 5 | ITO + thin Cu line 1 | 10.0 | 200 | |
| The invention | | | | |
| 6 | ITO + thin Cu line | 10.0 | 210 | |
| The invention | 0.1 | | | |
| 7 | ITO + thin Ag line 1 | 10.0 | 180 | |
| The invention | | | | |
| 8 | ITO + thin Cu line | 10.0 | 140 | Thick ITO with low |
| The invention | 0.01 | | | transparency |
| 9 | ITO + thin Cu line | 20.0 | 150 | |
| The invention | 0.1 | | | |
| 10 | ITO + thin Cu line | 1.0 | 180 | |
| The invention | 0.1 | | | |
| 11 | ITO + thin Ag line | 0.3 | 120 | |
| The invention | 0.1 | | | |
| 12 | ITO + thin Ag line | 10.0 | 130 | Thick ITO with low |
| The invention | 0.01 | | | transparency |

The device of Example 1 was (i) worked into a size of 0.1 m×0.25 m, and the relationship between the luminance and driving frequency was compared with that of (ii) a sample worked into a size of 0.5 m×0.8 m. The results are shown in Table 2. The upper case is the result of (i) the small-size device, and the lower case is the result of (ii) the large-size device. The results each shows a relative luminance assuming that the luminance obtained by driving Sample 2 in a size of 0.5 m×0.8 m at 1 kHz was 100.

TABLE 2

| | Sample 1, | Sample 2, | Sample 3, | Sample 5, |
|---|---|---|---|---|
| | Comparison | Comparison | Invention | Invention |
| 50 Hz | 3 | 7 | 7 | 41 |
| | 3 | 6 | 7 | 37 |
| 200 Hz | 20 | 23 | 24 | 80 |
| | 20 | 22 | 25 | 70 |
| 400 Hz | 41 | 45 | 55 | 140 |
| | 40 | 41 | 51 | 130 |
| 600 Hz | 65 | 67 | 78 | 200 |
| | 60 | 60 | 75 | 190 |
| 1 kHz | 110 | 110 | 140 | 200 |
| | 90 | 100 | 130 | 210 |
| 2 kHz | 190 | 200 | 260 | 380 |
| | 140 | 160 | 235 | 360 |
| 4 kHz | 250 | 280 | 380 | 730 |
| | 180 | 200 | 350 | 700 |
| 6 kHz | 300 | 350 | 450 | 1000 |
| | 170 | 210 | 400 | 970 |

The luminance shown above is relative luminance assuming that the luminance obtained by driving (ii) the large-size device of Sample 2 at 100 V and 1 kHz was 100. It is seen that in the electroluminescent device of the present invention, as the area is larger and as the driving frequency is higher and 500 Hz or more, higher luminance can be relatively realized.

### Example 2

Samples 101 and 102 were produced in the same manner as Samples 1 and 5 of Example 1 except for changing the amount of MgO at the baking of Phosphor Particle A in Example 1 and fabricating the device by a 100% Phosphor Particle A-type method (accordingly, these were not a white-emitting device). In these Samples, Phosphor Particle A was dispersed in a melamine-based thermoplastic resin to give an emission color of x=3.3±0.2 and y=3.4±0.2 on the CIE chromaticity coordinate, and mixed and added in the light emitting layer. Also, device samples 103 to 112 shown in Table 3 were produced by optimally using Ultraviolet Absorbent B-1 or B-2 and Antioxidant C-1 or C-2. Samples obtained each was driven by controlling the voltage to give the same initial relative luminance of 200 as in Example 1 (accordingly, in the case of device of Sample 1 type, the voltage was relatively elevated) while irradiating a mercury lamp of 500 lux under the temperature and humidity conditions of 25° C. and 60% similarly to Example 1, and the change in the relative luminance was determined. The results are shown in Table 3. It is seen that in the electroluminescent device of the present invention, the life is long and the change in color balance is small.

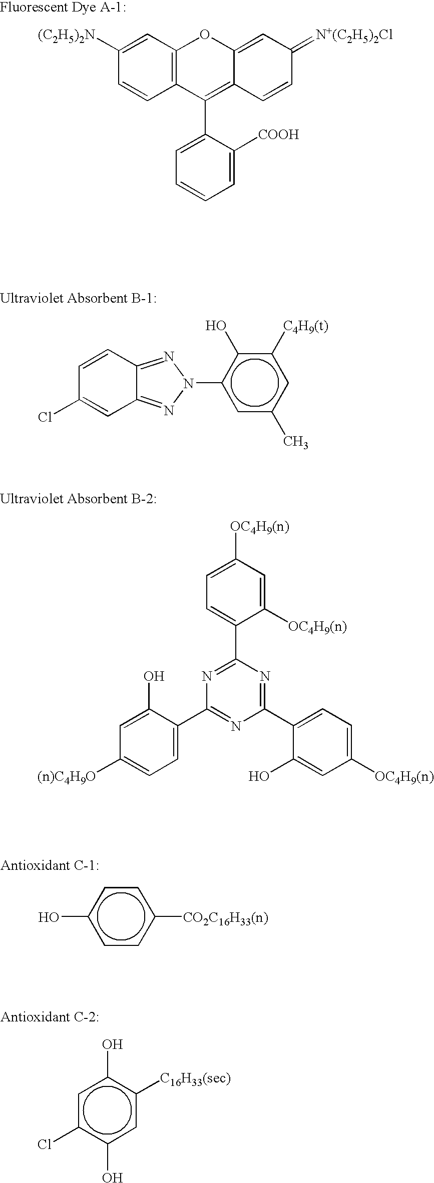

TABLE 3

| | | | Reduction of Initial Luminance and |
|---|---|---|---|
| | Ultraviolet | Anti- | Change in Color after Driving at |
| Sample | Absorbent | oxidant | 1 kHz for 500 Hours |
| 101 | none | none | Large reduction of luminance. |
| Sample 1 type | | | Color was changed to bluish |
| | | | green. |
| 102 | none | none | Small reduction of luminance. |
| Sample 5 type | | | Color hue was changed to blue. |
| 103 | B-1 | none | Large reduction of luminance. |
| Sample 1 type | | | Color hue was changed to bluish |
| | | | green. |
| 104 | none | C-1 | Large reduction of luminance. |
| Sample 1 type | | | Color hue was changed to bluish |
| | | | green. |
| 105 | B-1 | C-1 | Small reduction of luminance. |
| Sample 1 type | | | Color hue was less changed. |
| 106 | B-2 | none | Small reduction of luminance. |
| Sample 5 type | | | Color hue was changed to bluish |
| | | | green. |
| 107 | none | C-2 | Small reduction of luminance. |
| Sample 5 type | | | Color hue was changed to bluish |
| | | | green. |
| 108 | B-2 | C-2 | Very small reduction of luminance. |
| Sample 5 type | | | Color hue was less changed. |
| 109 | B-1 | C-2 | Small reduction of luminance. |
| Sample 1 type | | | Color hue was less changed. |
| 110 | B-2 | C-1 | Small reduction of luminance. |
| Sample 1 type | | | Color hue was not changed. |
| 111 | B-1 | C-2 | Very small reduction of luminance. |
| Sample 5 type | | | Color hue was not changed. |
| 112 | B-2 | C-1 | Very small reduction of luminance. |
| Sample 5 type | | | Color hue was not changed. |

It is seen from Table 3 that in the electro-luminescent device of the present invention, the reduction of luminance is small and the change in color balance is also small.

The present application claims foreign priority based on Japanese Patent Application No. JP2003-408656, filed Dec. 8 of 2003, the contents of which is incorporated herein by reference.

1. An electroluminescent device comprising:
a transparent conductive film comprising at least one of a transparent metal oxide and an organic material; and
a net-like structure comprising a thin metal line.

2. The electroluminescent device as claimed in claim 1, wherein the transparent conductive film has a surface resistivity of 0.01 to 100 Ω/□.

3. The electroluminescent device as claimed in claim 1, wherein the transparent metal oxide comprises an oxide of at least one of tin, zinc, antimony and indium.

4. The electroluminescent device as claimed in claim 1, wherein the organic material comprises a conjugated polymer.

5. The electroluminescent device as claimed in claim 1, wherein the thin metal line has a thickness of 0.5 to 20 μm.

6. The electroluminescent device as claimed in claim 1, wherein the net-like structure has a line pitch of 50 μm to 100 mm.

7. The electroluminescent device as claimed in claim 1, which comprises: a fluorescent dye; an antioxidant; and an ultraviolet absorbent.

8. The electroluminescent device as claimed in claim 1, which comprises a phosphor particle having an average equivalent-sphere diameter of 0.1 to 15 μm.

9. An electroluminescent device comprising:
a transparent conductive film comprising at least one of a transparent metal oxide and an organic material; and
a striped structure comprising a thin metal line.

10. An electroluminescent device comprising: a fluorescent dye; an antioxidant; and an ultraviolet absorbent.

11. The electroluminescent device as claimed in claim 10, which comprises a phosphor particle having an average equivalent-sphere diameter of 0.1 to 15 μm.

12. A flat light source system comprising an electroluminescent device as claimed in claim 1, wherein the electroluminescent device is driven by an AC electric field of 500 Hz to 5 kHz.

13. A flat light source system comprising an electroluminescent device as claimed in claim 10, wherein the electroluminescent device is driven by an AC electric field of 500 Hz to 5 kHz.
